(19) United States
(12) Patent Application Publication
(10) Pub. No.: US 2002/0030783 A1
(43) Pub. Date: Mar. 14, 2002

(54) Liquid crystal display and method for fabricating the same

(75) Inventor: Kouichi Taniguchi, Kagoshima (JP)

Correspondence Address: SONNENSCHEIN NATH & ROSENTHAL, 80th Floor - Sears Tower, 233 S. Wacker Drive, Chicago, IL, 60606, US

(73) Assignee: Sony Corporation

(21) Appl. No.: 09/740,552

(22) Filed: Sep. 19, 2001

(30) Foreign Application Priority Data
Dec. 21, 1999 (JP) P11-362685

(51) Int. Cl. G02F 1/1339

(52) U.S. Cl. 349/153; 349/190

(57) ABSTRACT

A liquid crystal display having a seal pattern which can readily be formed without using the screen printing method nor dispense method is proposed. In such a liquid crystal display, an opposite substrate and a TFT substrate respectively have on the periphery along the edge thereof seal patterns. The seal patterns are preliminarily formed in the semiconductor processes for fabricating pixel patterns on the opposite substrate and the TFT substrate using of course the same apparatuses used for proceeding such semiconductor processes. The individual seal patterns are corrugated on the surface thereof so as to be engaged with each other. Thus the surface portions of the individual seal patterns are adhered under fusion by stacking both substrates and by heating the seal patterns to a predetermined temperature while being applied with a predetermined pressure, to thereby join both seal patterns in an adhered manner.

### BACKGROUND OF THE INVENTION

1. Field of the Invention

The present invention relates to a liquid crystal display and a method for fabricating thereof, and more specifically to a structure of a seal member for sealing liquid crystal within a gap between a drive substrate having TFTs (thin film transistors) or the like and an opposite substrate.

2. Description of the Related Art

There is known a liquid crystal display (LCD) having a TFT substrate on which TFTs for driving liquid crystal are mounted, and an opposing substrate on which opposite electrodes as opposed to such TFTs are mounted, wherein both substrates are joined so as to be faced with each other as interposed with spacers and seal members, and liquid crystal is injected into a gap formed between the substrates through an injection hole provided to a portion of the seal member.

FIG. 7 is a flow chart showing a part of process steps for fabricating the TFT substrate and opposite substrate of such liquid crystal display, where as for the TFT substrate, the process steps related to semiconductor wafer processes have already finished.

First, the TFT substrate and opposite substrate are cleaned (S1, S11), and an orientation film is formed by coating (S2, S12) on the respective substrates.

The orientation films are then subjected to rubbing which is a process for converting the films into those capable of orienting liquid crystal (S3, S13), and again cleaned (S4, S14).

Next, spacers (micro-spheres of several micrometers in diameter made of resin or glass) for keeping a uniform spacing between both substrates in the pixel area are scattered on the TFT substrate (S5).

On the other hand, the opposite substrate is coated with a seal material for forming a liquid crystal cell when joined with the TFT substrate faced therewith (S15).

Then both substrates are joined to form the pixel area (S21), liquid crystal is injected into such pixel area (S22), and a hole through which the liquid crystal was injected is sealed (S23).

In such fabrication process of a liquid crystal display, screen printing method or dispense method is generally adopted for coating the seal material on the opposite substrate.

The screen printing method will be described hereinafter.

FIG. 8 shows a schematic plan view of a screen plate used in the screen printing method, and FIGS. 9A and 9B are a plan view and a sectional view, respectively, of the screen plate shown in FIG. 8.

As shown in FIG. 8, a screen plate 10 comprises a frame 20 and a screen sheet 12 made of silk or the like stretched thereon, wherein the screen sheet 12 is selectively coated with a resin to thereby provide a coating pattern 14 for the seal material.

A general type of the screen sheet 12 is composed of woven thin wires made of silk or the like, and from both sides of which a resin 16 is coated.

The resin 16 is selectively removed according to a pattern of coating the seal material, so that the seal material can pass through the screen sheet 12 only in the area where the seal material is removed.

Such screen sheet 12 is used as being tightly stretched on the frame 20.

FIG. 10 is a transverse sectional view (taken along the line X-X in FIG. 8) showing a coating process of a seal material 22 through the screen plate 10, and FIG. 11 is an enlarged view showing an essential portion of FIG. 10.

As illustrated in the figure, the seal material 22 (with a viscosity of several tens of thousands Cp to hundred and ten-odd thousands Cp) placed on the screen plate 10 is applied on a substrate 26 as a squeegee (blade) 24 moves in parallel therewith while being pressed onto the screen plate 10.

The dispense method will be explained hereinafter.

FIGS. 12A and 12B are side views showing states in which the seal material is coated by the dispense method.

A seal material 34 is filled in a cylinder 30, and is discharged from the tip of a needle 32 with the aid of compressed air, to thereby draw a seal pattern 34A on the substrate 36.

FIG. 13 is a view for explaining the joining of the opposite substrate on which the seal material is thus provided and the TFT substrate, and FIG. 14 is a fragmentary sectional view showing a state that both substrates are joined as interposed with the seal material.

As illustrated in the figure, the seal material 41 is applied on the periphery along the edge of the opposite substrate 42, and seals the gap between the opposite substrate 42 and a TFT substrate 43 by coming into close contact therewith.

Such conventional methods for coating the seal material, however, suffer from the problems described below.

The screen printing method requires the squeegee 24 to be pressed onto the screen plate 10, so that the screen plate 10 and the orientation film 28 coated on the substrate 26 readily come into contact to thereby contaminate the orientation film 28 by substances which have been adhered on the screen plate 10, or to give physical damage to the orientation film 28. This may result in orientation failure, image failure and so forth.

Whereas in the dispense method, it is necessary to move either of a stage (not shown) on which the substrate 36 is placed or the needle 32 so as to trace the shape of the seal pattern, which is time consuming.

Another problem resides in that the gap between the tip of the needle 32 and the substrate 36 must be kept constant so that a highly precise control thereof is required.

In case of entrainment of air bubbles within the seal material 34 as shown in FIG. 12B, the seal pattern obtained by coating may become fragmentary.

### SUMMARY OF THE INVENTION

It is therefore an object of the present invention to provide a liquid crystal display which can easily form a seal pattern without using the screen printing method nor dispense method, and a method for fabricating such a liquid crystal display.

To accomplish the foregoing object, a liquid crystal display of the present invention comprises a drive substrate having active devices mounted thereon for driving liquid crystal; an opposite substrate having opposite electrodes provided thereon as opposed to the active devices; a seal pattern for joining both substrates so as to be faced with each other and uniformly spaced with a gap; and liquid crystal filled in such gap, in which the seal pattern is provided on at least either of such drive substrate or opposite substrate in a film forming step for forming pixels.

To accomplish the foregoing object again, a method for fabricating a liquid crystal display of the present invention comprises the steps of forming on a drive substrate active devices for driving liquid crystal; forming on an opposite substrate opposite electrodes as opposed to such active devices; forming a seal pattern on at least either of such drive substrate or opposite substrate; joining as interposed with such seal pattern both substrates so as to be faced with each other and uniformly spaced with a gap; and filling liquid crystal into such gap, in which such seal pattern is formed in a film forming step for forming pixels.

According to the liquid crystal display and the method for fabricating such a liquid crystal display, the seal pattern is preliminarily formed in a film forming step at the same time with the formation of the pixel pattern on the drive substrate and opposite substrate. The joining of these substrates is effected as interposed with the seal pattern, where the seal pattern comes into close contact with both substrates to thereby seal the gap between both substrates.

It is thus no more necessary in the fabrication of the liquid crystal display of the present invention to provide the seal material for sealing the gap between both substrates by a special equipment or step such as needed in screen printing or dispensing method, so that the seal pattern can readily be formed, which is beneficial in simplifying and improving efficiency of the fabrication process.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a schematic view for explaining joining of an opposite substrate and a TFT substrate according to an embodiment of the present invention;

FIGS. 2A and 2B are fragmentary sectional views showing the opposite substrate, the TFT substrate and a seal pattern shown in FIG. 1;

FIG. 3 is a fragmentary sectional view showing another example of the opposite substrate, the TFT substrate and the seal pattern shown in FIG. 1;

FIG. 4 is a fragmentary sectional view showing still another example of the opposite substrate, the TFT substrate and the seal pattern shown in FIG. 1;

FIG. 5 is a flow chart showing a part of process steps for forming a pixel pattern on the TFT substrate shown in FIG. 1;

FIG. 6 is a flow chart showing a part of process steps for forming a pixel pattern on the opposite substrate shown in FIG. 1;

FIG. 7 is a flow chart showing a part of process steps for fabricating a TFT substrate and an opposite substrate of a conventional liquid crystal display;

FIG. 8 is a schematic plan view of a screen plate used for screen printing;

FIGS. 9A and 9B are a plan view and a sectional view respectively showing a detailed structure of the screen plate shown in FIG. 8;

FIG. 10 is a transverse sectional view showing a coating process of a seal material using the screen plate shown in FIG. 8;

FIG. 11 is an enlarged view of an essential portion of FIG. 10;

FIGS. 12A and 12B are schematic side views showing a coating process of a seal material by the dispense method;

FIG. 13 is a schematic plan view showing joining of an opposite substrate provided with a seal material and a TFT substrate in the conventional liquid crystal display; and

FIG. 14 is a fragmentary sectional view showing a joined state of the opposite substrate and the TFT substrate shown in FIG. 13 as interposed with the seal material.

### DESCRIPTION OF THE PREFERRED EMBODIMENT

An embodiment of the liquid crystal display of the present invention will be explained hereinafter.

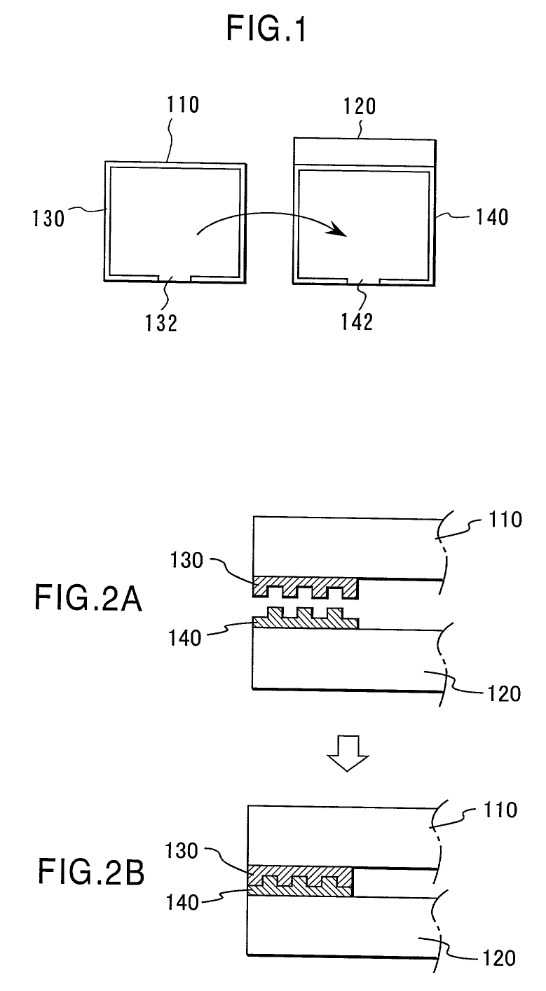

FIG. 1 is a schematic view for explaining joining of an opposite substrate and a TFT substrate (drive substrate) according to an embodiment of the present invention.

As illustrated in the figure, an opposite substrate 110 and a TFT substrate 120 individually have seal patterns 130, 140 on the periphery along the edge thereof. The seal patterns 130, 140 have omitted portions 132, 142, respectively, through which liquid crystal is injected into a gap formed between both substrates.

The seal patterns 130, 140 are preliminarily formed in film forming steps in semiconductor wafer processes for fabricating pixel patterns on the opposite substrate 110 and the TFT substrate 120 using of course the same apparatuses used for proceeding such semiconductor wafer processes.

FIG. 2A is a fragmentary sectional view enlargedly showing the individual substrates 110, 120 together with the seal patterns 130, 140 provided thereon, and FIG. 2B is a fragmentary sectional view showing the individual substrates 110, 120 joined with the seal patterns 130, 140 therebetween.

As illustrated in the figures, the individual seal patterns 130, 140 are corrugated on the surface thereof so as to be engaged with each other. Thus the surface portions of the individual seal patterns 130, 140 are adhered under fusion by stacking both substrates 110, 120 and by heating the seal patterns 130, 140 to a predetermined temperature while being applied with a predetermined pressure, to thereby join both seal patterns 130, 140 in an adhered manner as shown in FIG. 2B.

It is now general in the liquid crystal display that spacers are provided between a TFT substrate and an opposite substrate for the purpose of keeping a uniform spacing between both substrates. This is because the seal material used in the conventional liquid crystal display is generally a liquid substance and, as explained in the above description, is coated immediately before the joining of both substrates so that the seal material cannot ensure a strength sufficient for keeping an uniform spacing between both substrates.

On the contrary in the liquid crystal display of the present invention, the seal patterns 130, 140 preliminarily provided on the individual substrates 110, 120 are in a solid state with a certain level of hardness when such substrates 110, 120 are joined.

Thus the seal patterns 130, 140 can exhibit strength sufficient for keeping a uniform spacing between both substrates 110, 120 stacked with each other. While the surface portion of the seal patterns 130, 140 may be deformed ascribable to the fusion, the amount of the deformation is desirably limited within a certain range.

Thus by making use of such strength of the seal patterns 130, 140 and alignment accuracy of an assembly apparatus (not shown) used for joining both substrates 110, 120, and by properly controlling the gap between the substrates 110, 120, the joining can successfully be carried out without using the spacers. This is also beneficial in that the gap can precisely be defined by the thickness of the seal patterns 130, 140 provided on the substrates 110, 120.

While the above embodiment did not use the spacers, it is also allowable that the seal patterns preliminarily contain the spacers which are responsible for keeping a uniform spacing between the substrates. Any constitution such that separately employing the spacers in a portion other than the seal material, which is not directly related to features of the present invention, may be applicable.

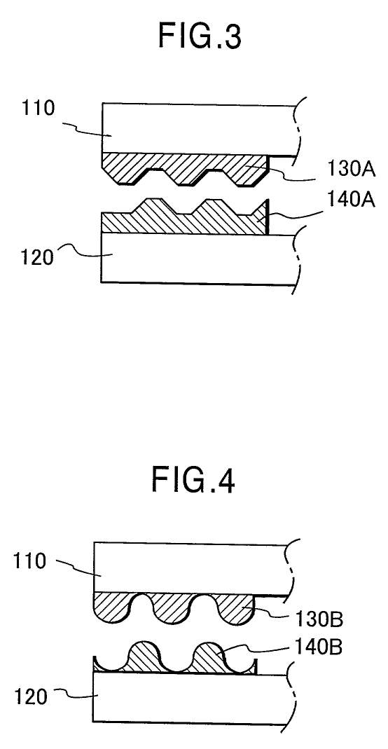

While the surfaces of the seal patterns 130, 140 are corrugated so as to have a rectangular profile in the example shown in FIG. 2, it is also allowable as shown in FIG. 3 to provide seal patterns 130A, 140A having a corrugation with a mesa profile, or it is still also allowable as shown in FIG. 4 to provide seal patterns 130B, 140B having a corrugation with a sine wave profile. Although being not shown, a corrugation with a triangle profile is also allowable. In short, any profile may be allowable so far as a desirable engagement and readiness in fusion can be ensured.

The paragraphs below will describe a method for producing the seal patterns 130, 140 at the same time with the formation of pixel patterns on the substrates 110, 120.

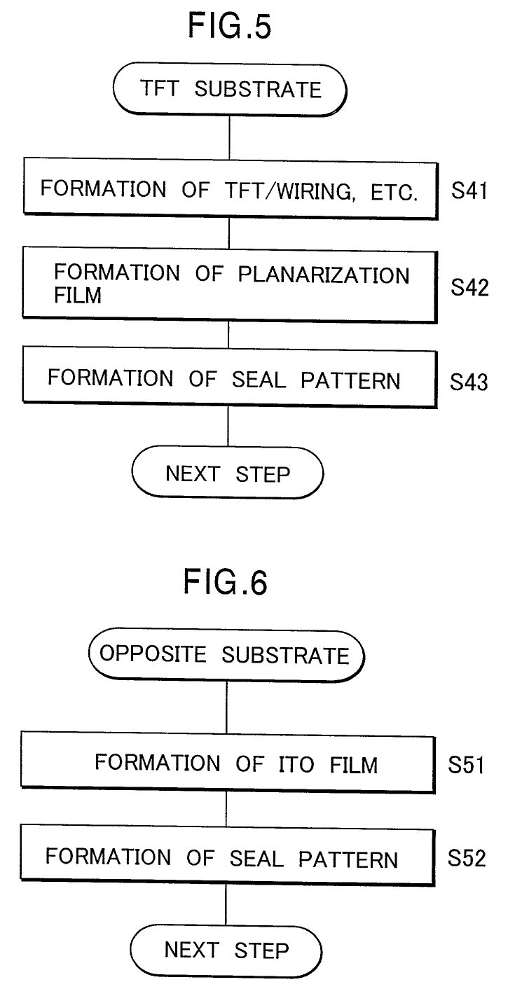

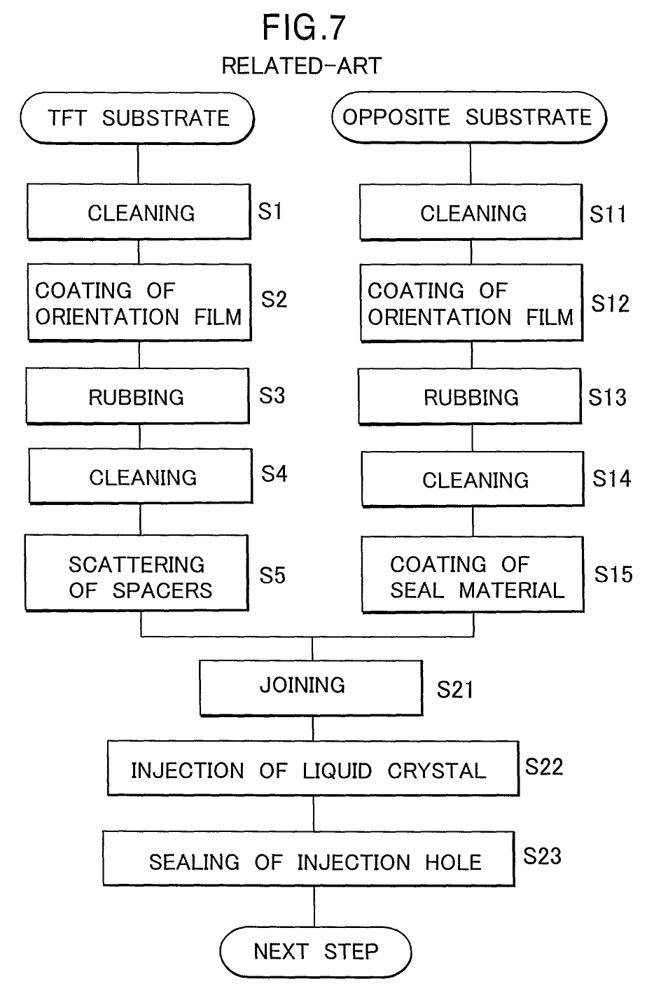

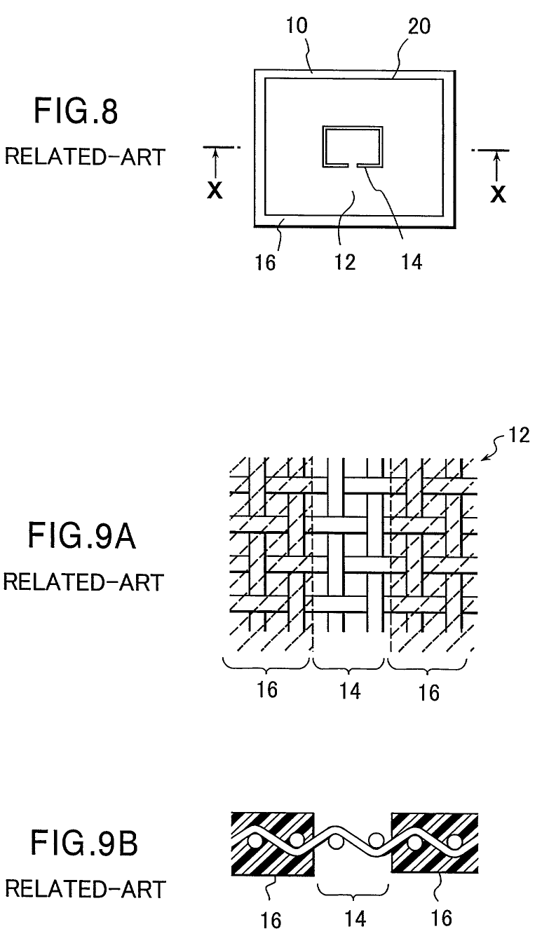

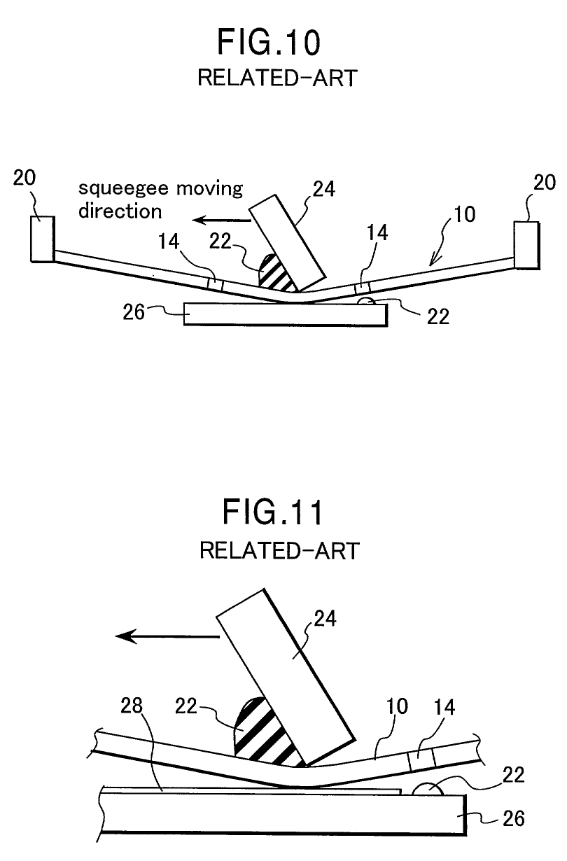

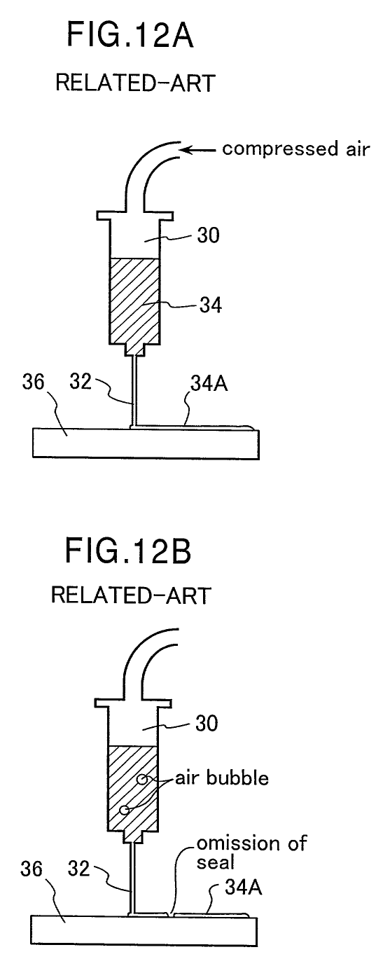

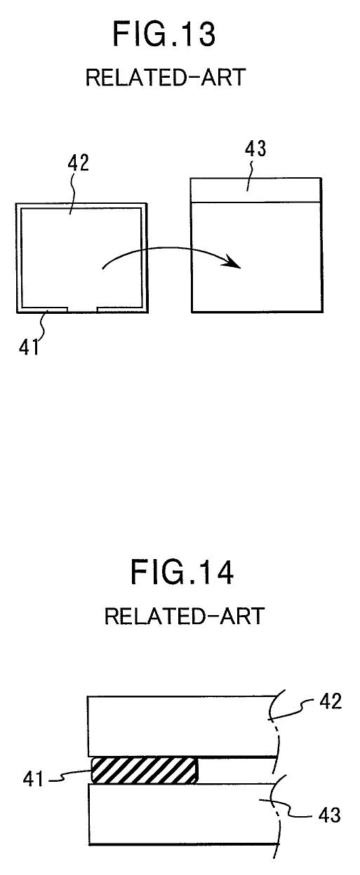

FIG. 5 is a flow chart showing a part of process steps for forming a pixel pattern on the TFT substrate 120.

In this process, TFTs, wirings and so forth are produced on a wafer made of, for example, glass or silicon based on general semiconductor processes such as lithography and etching (S41). Further thereon a planarization film made of a synthetic resin such as photo-reactive acrylic resin is formed (S42). The planarization film, on which an orientation film is to be formed, is provided to reduce the surface irregularity caused by the production of TFTs and so forth.

Now according to the same process with that for the planarization film, a seal pattern is formed using a synthetic resin such as photo-reactive acrylic resin (S43).

That is, a seal film is formed by the spin coating method in which a liquid material for forming a seal film is dropwisely fed onto the wafer rotating at a high speed. The thickness of the seal pattern can be controlled depending on the number of rotation.

After the seal film is dried, a mask having a pattern corresponded to the seal pattern is provided on the seal film, and the seal film is submitted to light exposure through such mask, by which the seal film is selectively hardened within an exposed area. The mask is then removed, and the seal mask is developed (by water washing, for example) to thereby remove the unnecessary portion of such seal mask and to leave only the seal pattern.

After drying, the seal pattern is processed on the surface thereof by general procedures of lithography and etching to form the above described corrugation.

The wafer is then divided into the individual TFT substrates for the individual liquid crystal display, and the obtained TFT substrates are then subjected to various processes such as the formation of an orientation film.

FIG. 6 is a flow chart showing a part of process steps for forming a pixel pattern on the opposite substrate 110.

In this step, a transparent electrode film made of ITO (indium tin oxide) is formed on a wafer made of, for example, glass by sputtering (S51). Further thereon a seal pattern made of a synthetic resin such as photo-reactive acrylic resin is formed (S52).

That is, a seal film is formed by the spin coating method in which a liquid material for forming a seal film is dropwisely fed onto the wafer rotating at a high speed. Again the thickness of the seal pattern can be controlled depending on the number of rotation.

After the seal film is dried, a mask having a pattern corresponding to the seal pattern is provided on the seal film, and the seal film is submitted to light exposure through such mask, by which the seal film is selectively hardened within an exposed area. The mask is then removed, and the seal mask is developed (by water washing, for example) to thereby remove the unnecessary portion of such seal mask and to leave only the seal pattern.

After drying, the seal pattern is processed on the surface thereof by general procedures of lithography and etching to form the above described corrugation.

The wafer is then divided into the individual opposite substrates for the individual liquid crystal display, and the obtained opposite substrates are then subjected to various processes such as the formation of an orientation film.

As has been described in the above, the seal patterns can be formed in the pixel pattern forming process for the individual substrates, and the production thereof no more requires screen printing apparatus or dispense apparatus which were described in relation to the conventional example. Thereafter, in accordance with general procedures, both substrates are joined, liquid crystal is injected into the gap, and a hole through which the liquid crystal was injected is sealed, to thereby finish the liquid crystal display of the present invention.

For example, although the seal pattern was individually provided to both of the TFT substrate and opposite substrate, it is also allowable that only either one of the substrates has the seal pattern provided that a sufficient level of the sealing can be ensured. The seal pattern can be formed not only by the spin coating method but also by a scan coating method. Furthermore, as the material used for the seal pattern not only the synthesis resin but also an inorganic film such as an SOG material may be used.

Although the invention has been described in its preferred form with a certain degree of particularity, obviously many changes and variations are possible therein. It is therefore to be understood that the present invention may be practiced otherwise than as specifically described herein without departing from the scope and the spirit thereof.

What is claimed is:

1. A liquid crystal display comprising:
a drive substrate having active devices mounted thereon for driving liquid crystal;
an opposite substrate having opposite electrodes provided thereon as opposed to said active devices;
a seal pattern for joining both substrates so as to be faced with each other and uniformly spaced with a gap; and
liquid crystal filled in such gap, wherein
said seal pattern is provided on at least either one of said drive substrate and said opposite substrate in a film forming step for forming pixels.

2. The liquid crystal display as claimed in claim 1, wherein said seal pattern joins both substrates through being fused on a surface thereof by heating to thereby ensure close contact.

3. The liquid crystal display as claimed in claim 1, wherein said seal pattern joins both substrates through being pressurized on a surface thereof by pressing to thereby ensure close contact.

4. The liquid crystal display as claimed in claim 1, wherein said seal pattern is provided on said drive substrate, and is formed on a planarization film which covers the active devices formed on said drive substrate.

5. The liquid crystal display as claimed in claim 1, wherein said seal pattern is provided on said opposite substrate, and is formed on a transparent electrode film which covers said opposite substrate.

6. The liquid crystal display as claimed in claim 1, wherein said seal pattern is obtained by the steps of:
forming on a semiconductor substrate to be processed into said drive substrate or opposite substrate a seal film for forming said seal pattern by spin coating;
providing said seal film with a mask;
submitting said seal film to light exposure through said mask; and
developing the exposed seal film.

7. The liquid crystal display as claimed in claim 2, wherein said seal pattern is corrugated on the surface thereof so as to readily be fused by heating.

8. The liquid crystal display as claimed in claim 7, wherein said seal patterns are provided on both of said drive substrate and said opposite substrate, and the individual surfaces of said seal patterns are corrugated so as to be engaged with each other to thereby allow both substrates to be joined as engaged through the seal patterns, and facilitate the sealing between said substrates.

9. A method for fabricating a liquid crystal display, comprising the steps of:
forming on a drive substrate active devices for driving liquid crystal;
forming on an opposite substrate opposite electrodes as opposed to said active devices;
forming a seal pattern on at least either one of said drive substrate and said opposite substrate;
joining as interposed with said seal pattern both substrates so as to be faced with each other and uniformly spaced with a gap; and
filling liquid crystal into said gap, wherein
said seal pattern is formed in a film forming step for forming pixels.
